(19) United States
(12) Patent Application Publication
(10) Pub. No.: US 2013/0290025 A1
(43) Pub. Date: Oct. 31, 2013

(54) SOFTWARE AND METHODS FOR ORGANIZING HEALTH DATA

(71) Applicant: Gina Karlin Haldeman, Alexandria, VA (US)

(72) Inventor: Gina Karlin Haldeman, Alexandria, VA (US)

(21) Appl. No.: 13/870,965

(22) Filed: Apr. 25, 2013

Related U.S. Application Data
(60) Provisional application No. 61/639,977, filed on Apr. 29, 2012.

(51) Int. Cl. G06F 19/00

(52) U.S. Cl. CPC G06F 19/322
USPC 705/3

(57) ABSTRACT

Software and methods for organizing health data uses a patient's health information to produce a list of actions (such as tests, procedures, labs, counseling and the like) that should be done at a specific time. The software can be used for any branch of health care. When used for prenatal care, the software can follow the patient throughout her pregnancy and insure that her care is tailored to her specific health care health needs. For every problem that is on the problem list, there is a list of additional tests and counseling, suggested by medical experts as “best practices”.

### CROSS-REFERENCE TO RELATED APPLICATION

This application claims the benefit of priority of U.S. provisional application No. 61/639,977, filed Apr. 29, 2012, the contents of which are herein incorporated by reference.

### BACKGROUND OF THE INVENTION

The present invention relates to software and methods for organizing health data and, more particularly, to software and methods for organizing health data that can produce a list for tests and counseling in chronological order.

Patients getting health care often have multiple health problems. Each problem can alter the care that the patient needs. It is difficult to customize the care for each patient without forgetting tests or counseling.

Health care providers can forget to offer important tests or important counseling. Some tests are time-specific and cannot be performed after a certain point. This is particularly true during prenatal care. The result can be inferior health care, making the health care provider vulnerable to liability. Patients currently do not have any applications available that can organize their health care.

Current electronic health records (EHR) or electronic medical records (EMR) systems only have a place to enter health problems. They record the history of what has been diagnosed and treated in the past. They do not suggest a list of actions (tests, procedures, labs, counseling and the like) that should be performed in the future. Health care providers are expected to just know what to do and when to do it. Most patients have no ideas what care they should be expecting, because they have limited access to the information. The current software does not organize tests in any way—chronologically or otherwise. Moreover, current software does not keep a record of the date that all tests were offered, but declined by the patient.

As can be seen, there is a need for a software application and methods for organizing health data and using a patient's health information to produce a list of actions that should be done at a specific time.

### SUMMARY OF THE INVENTION

In one aspect of the present invention, a computer implemented method for organizing health data comprises providing an input into a patient's medical record to create a patient health record; comparing data in the patient health record to a pre-set of values for ranges of normal and abnormal for the data; outputting a set of actions based on best practices; and providing a chronological action list based on the set of actions.

In another aspect of the present invention, a computer implemented method for organizing health data comprises providing an input into a patient's medical record to create a patient health record; comparing data in the patient health record to a pre-set of values for ranges of normal and abnormal for the data; automatically generating a problem list based on the data in the patient health record; outputting a set of actions based on best practices; providing a chronological action list based on the set of actions; allowing a user to enter a date when an item in the chronological action list is marked complete; and associating at least a portion of the chronological action list with the problem list.

These and other features, aspects and advantages of the present invention will become better understood with reference to the following drawings, description and claims.

### BRIEF DESCRIPTION OF THE DRAWINGS

FIG. 1 is a flow chart describing the software and methods according to an exemplary embodiment of the present invention;

FIG. 2 is a flow chart, filled-in, showing an exemplary OB flowchart and action list;

FIG. 3 is a blank flow chart, showing an exemplary OB flowchart and action list; and

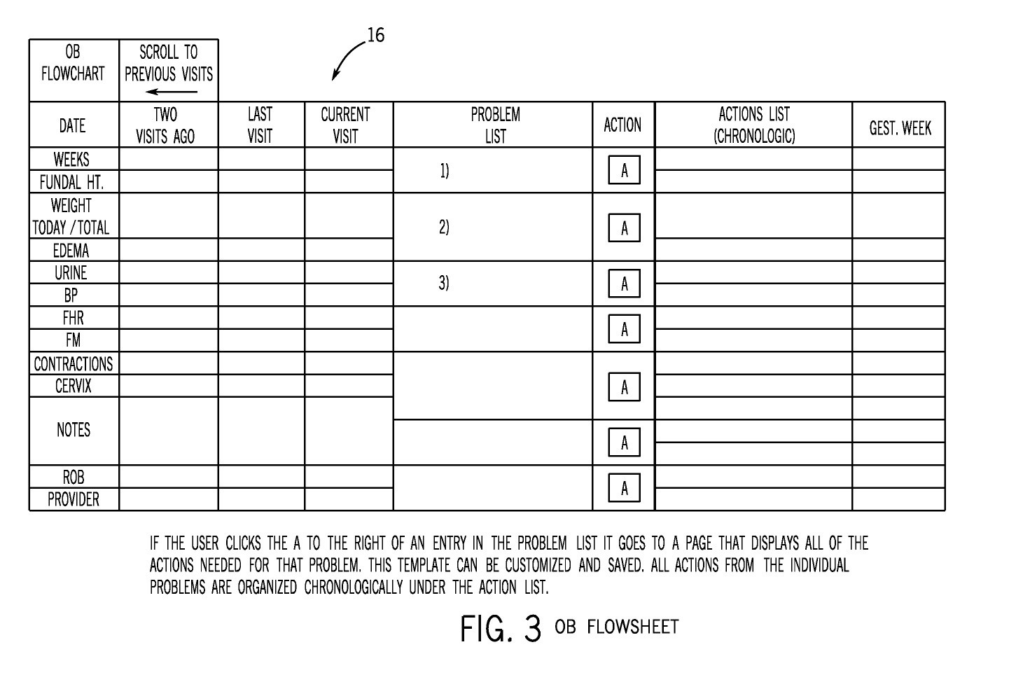

FIG. 4 is a schematic view of an action template for a specific OB problem of advanced maternal age.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides software and methods for organizing health data by using a patient's health information to produce a list of actions (such as tests, procedures, labs, counseling and the like) that should be done at a specific time. The software can be used for any branch of health care. When used for prenatal care, the software can follow the patient throughout her pregnancy and insure that her care is tailored to her specific health care health needs. For every problem that is on the problem list, there is a list of additional tests and counseling, suggested by medical experts as “best practices”.

When used by a health care provider, the software can produce a list of actions due to be done for the patient. Because the action list is chronological, no time-sensitive tests would be missed. When used by a patient, they would have an application that would let them see what care was due on any particular time period. There is still very little standardization in medical care that reflects “best practices” as recommended by medical experts. The software of the present invention would encourage uniform care of the highest standards.

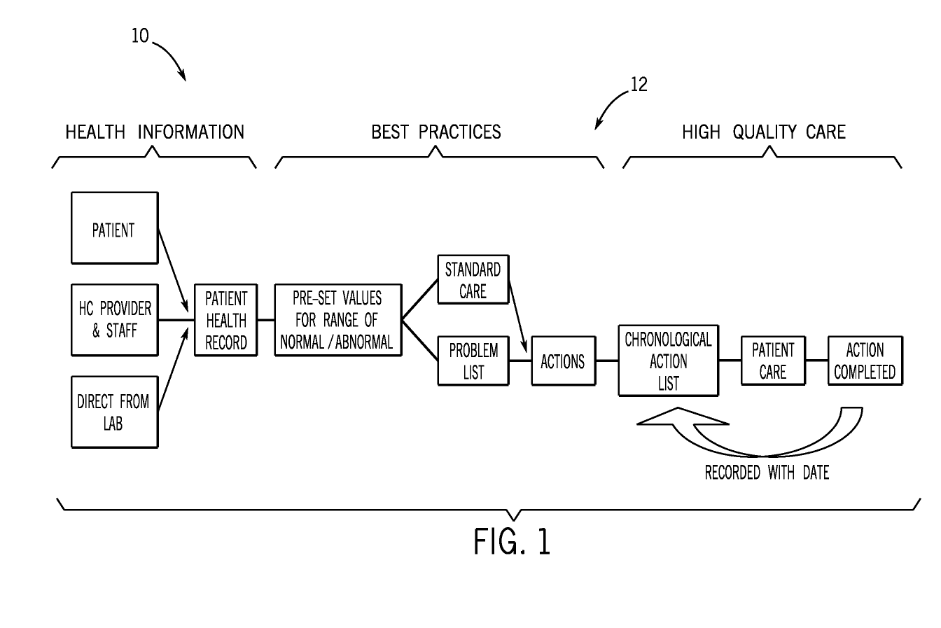

For every problem that is on the problem list there is a suggested list of additional tests and counseling. More and more, the medical community is identifying “best practices”. These are based on the latest research. Medical organizations, such as the American Congress of Obstetricians and Gynecologists (AGOG) also identify best practices. Other health organizations, like the Center for Disease Control (CDC) and the World Health Organization (WHO) also identify best practices. The user can use a suggested list, suggesting identified best practices 12 (see FIG. 1), or delete each individual test by deselecting a check mark. Additional tests can be added using a search feature, until the care has been customized for that user.

It would not be necessary to include best practice suggestions for actions (procedures, tests, labs, counseling). The health care provider could choose all of their own actions. For the patient's application, it would be necessary to list suggested actions for the patient. In an exemplary embodiment, the health care provider has an application that they can give their patients that exactly matches the software the health care provider is using.

Referring to the Figures, the user (either a health caregiver or a patient) enters health information 10 into the software program through the EMR or Smart phone application, for example. Some information would be entered by choosing numbers, for example date of birth, height, weight, and the like. The user would go through lists of health conditions and choose all that applied by clicking on a box. Common health problems would be listed, like high blood pressure. There would also be a place to enter any additional problems not listed. Typically, in an obstetrics (OB) application, only problems selected for pregnancy would be used to generate actions for pregnancy and some health issues would not need to be put on the OB problem list, such as menstrual pain.

For each problem there is a pre-set suggested set of actions, each with a time the action should be done. These procedures, tests, labs, and counseling can be deselected, if not desired. Additional actions can be chosen from a master list and added by the user. For each health problem, there would be a button to select if it was an active problem, rather than just in the patient history. A template 16 for a plan of care would be available for each active problem. The template could be customized by the user. Also built into the software system would be templates for specialized care. This care could be standard prenatal care, or pediatric care, oncology care or rehabilitation. These templates could also be customized by the user. For each action, there is a time that it should be performed, also customizable. All templates could be changed—either for that patient only, or for all patients.

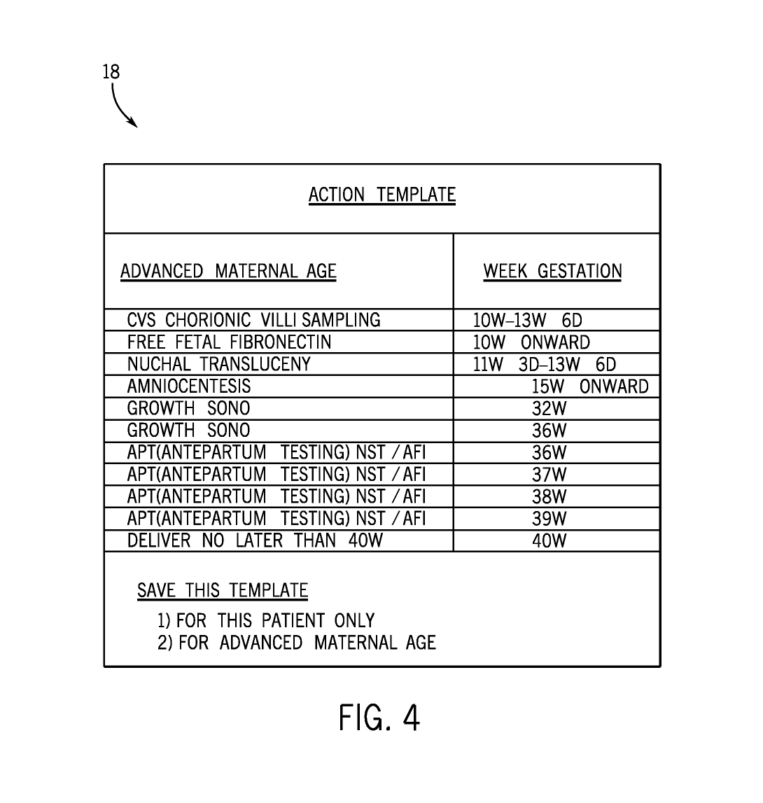

In a separate area, the software would organize all of the actions from all of the problems into a chronological list 18, as shown in FIG. 4. This list would represent the entire plan of care. If used for pregnancy, it would list all of the prenatal care to be given. If used for pediatric care a health care provider or parent would see all of the care needed starting at the youngest age. For chemotherapy, the entire course of treatment would be outlined. Typically, the action that is due next is at the top of the action list. If the user scrolls down the page, actions can be viewed that are due at a later date. If the user scrolls up the page, then actions that have already been performed can be viewed.

Once an action has been performed and the patient has either received the care or declined the care, then the action is marked complete with the date it was completed. Then, the action is placed by the system, from the chronologic plan of care into the chronological action history, according to when it was completed. The completed action could also be viewed on the screen that shows the specific action for each individual problem. This leaves the user with an accurate list of actions that have not yet been taken. The software would also document the date that an action was declined. This provides a permanent record of tests that were offered to the patient by the health care provider which could be very important, if there was a case that went to litigation.

Aspects of the present invention include software. The software can be written in computer code and stored on a computer readable medium. Software could be written that is able to take a problem chosen in one area and place it, with its dependent actions, on a problem list. Cloud-based servers could store and transfer data to the EMR and/or the application to create the chronological list of procedures, tests, labs, and counseling for individual patients on each visit.

Each action (procedure, test, lab, counseling) would have a time designated time frame. In a separate area, the actions could be viewed in chronological order.

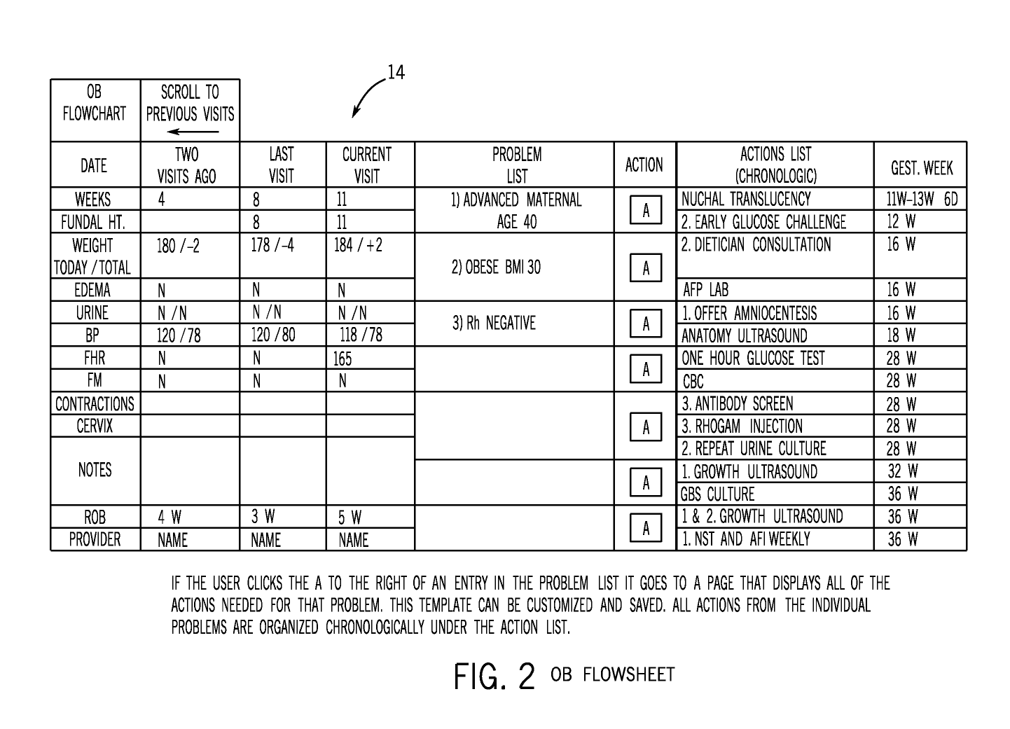

For example, as shown in the filled-in template 14 of FIG. 2, A) Date of Birth is entered that shows the patient is 40 years old which is an Advanced Maternal Age (AMA); B) The height and weight is entered and shows the patient has a Body Mass Index (BMI) of 30 which correlated to Obesity; and C) The patient is Rh factor negative.

The software would generate a Problem List with 3 entries: A) AMA; 2) Obesity; and C) Rh negative. Each of these problems would have some dependent actions. For Prenatal Care some actions would be: A) AMA: A1) Discuss CVS test, Nuchal Translucency and Amniocentesis 6 weeks of pregnancy; A2) Get Nuchal Translucency 11-13 weeks; and A3) Get Amniocentesis 16 weeks. A4) Growth Ultrasound 36w; B) Obesity: B1) Discuss weight gain 8 weeks; B2) Glucose Challenge test 10 weeks; B3) Repeat Urine Culture; B4) Growth Ultrasound 36w; and C) Rh negative : C1) Antibody Screen, then Rhogam Injection 28 weeks; C2) Repeat Rhogam Injection Post-partum if baby Rh Positive.

The Chronologic Plan of Care could include: A1) Discuss CVS test, Nuchal Transluceny and Amniocentesis 6 weeks; B1) Discuss weight gain 6 weeks; B3) Glucose Challenge test 10 weeks, A2) Get Nuchal Translucency 11 to 13 weeks; A3) Get Amniocentesis 16 weeks; Anatomy Ultrasound Routine for all patients, 28 week Glucose test and CBC Routine for all patients; C1) Antibody Screen, then Rhogam Injection 28 weeks; B2) Repeat Urine Culture; A4 & B4) Growth Ultrasound 36w.

As used by a patient, the application could be downloaded onto a personal interface which could be a smart phone, tablet, netbook, or laptop, for example. The application would allow the patient to enter health data. The application would create the Chronologic Plan of Care and the patient could view it any time, including during an appointment with the health care provider. The patient could be sure that the plan of care in their application matches the plan of care the health care provider is telling them about.

As used by a heath care provider, the Chronologic Plan of Care could be viewed before the patient visit or during the visit itself. It could also be printed out and given to the patient. The health care provider could have a downloadable version for the patient, as an application.

Any branch of health care can use the software of the present invention. It could also be incorporated into any industry that needs to modify a plan according to variable data. For example, new employees could check off areas of training with which they were not familiar. Then the software would create a training schedule tailored to the employee's needs. In this case, the “problem list” could be replaced by a list of “required training”. The action list would not be test and labs, but could be training units, for example.

It should be understood, of course, that the foregoing relates to exemplary embodiments of the invention and that modifications may be made without departing from the spirit and scope of the invention as set forth in the following claims.

What is claimed is:

1. A computer implemented method for organizing health data, comprising:
providing an input into a patient's medical record to create a patient health record;
comparing data in the patient health record to a pre-set of values for ranges of normal and abnormal for the data;
outputting a set of actions based on best practices; and
providing a chronological action list based on the set of actions.

2. The method of claim 1, further comprising allowing a user to enter a date when an item in the chronological action list is marked complete.

3. The method of claim 1, further comprising automatically generating a problem list based on the data in the patient health record.

4. The method of claim 3, further comprising associating at least a portion of the chronological action list with the problem list.

5. The method of claim 1, further comprising permitting manual entry of actions to be inserted into the chronological action list.

6. The method of claim 1, further comprising permitting removal of actions from the chronological action list.

7. The method of claim 1, wherein the computer implemented method is accessed via an internet connection to a database.

8. The method of claim 1, wherein the computer implemented method is accessed via a smartphone application.

9. A computer implemented method for organizing health data, comprising:
providing an input into a patient's medical record to create a patient health record;
comparing data in the patient health record to a pre-set of values for ranges of normal and abnormal for the data;
automatically generating a problem list based on the data in the patient health record;
outputting a set of actions based on best practices;
providing a chronological action list based on the set of actions;
allowing a user to enter a date when an item in the chronological action list is marked complete; and
associating at least a portion of the chronological action list with the problem list.

10. The method of claim 1, further comprising:
permitting manual entry of actions to be inserted into the chronological action list; and
permitting removal of actions from the chronological action list.
